(19) United States
(12) Patent Application Publication
(10) Pub. No.: US 2024/0408420 A1
(43) Pub. Date: Dec. 12, 2024

(54) MULTIFUNCTION DEVICE EQUIPPED WITH A LOCKING CAM AND A PULLEY FOR A SAFETY ROPE

(71) Applicant: ALUDESIGN S.P.A., Lecco (LC) (IT)

(72) Inventors: Ugo PEGURRI, Sovere (BG) (IT); Gianluca BRIOSCHI, Vignate (MI) (IT)

(21) Appl. No.: 18/698,029

(22) PCT Filed: Oct. 4, 2022
(86) PCT No.: PCT/IB2022/059451

§ 371 Date: Apr. 3, 2024

(30) Foreign Application Priority Data
Oct. 4, 2021 (IT) 102021000025394

(51) Int. Cl. A62B 1/14; B66D 3/04; F16D 63/00

(52) U.S. Cl. CPC A62B 1/14; B66D 3/046; F16D 63/008

(57) ABSTRACT

A multifunction device adapted to house at least one safety rope comprises a first fixed portion which defines a first passage for the rope; a first rotation axis; a second portion movable with respect to the first portion and connected to the first rotation axis to rotate between open and closed positions; a second rotation axis; a movable cam mounted on the second rotation axis to rotate between an interference position of the first passage and a free sliding position; a pulley mounted on the first axis; at least one first seat on the first portion and at least one second seat on the second portion at least partially coinciding to couple a first connector to the multifunction device and arranged in an area defined by two straight lines passing through the ends of a segment connecting the first and second rotation axes and perpendicular to the segment.

### FIELD OF THE INVENTION

The present invention relates to a multifunction device adapted to house at least one safety rope. In particular, the present invention concerns a multifunction device equipped with a locking cam as well as a pulley for a safety rope to secure a load, whether it is an object or a person, during work at height or sports practice.

The present invention is mainly used in the field of sport climbing equipment, for professional use in works at height and rescue operations.

It should be immediately noted that, in the present document, reference will be made to the locking and/or braking of the safety rope, meaning that the device of the invention can determine the locking of the rope, or the braking of the rope, or also the combination of a braking of the rope which then leads to the locking of the same rope.

### KNOWN PRIOR ART

In the context of works at height and sport climbing, a multitude of devices are available, each of which is, in practice, intended to a particular use by means of the cooperation with other elements typically being part of the equipment for these operations, such as ropes, sheaves, brakes, locking devices, karabiners and harnesses.

Works at height or climbing sports are particularly dangerous and it is not uncommon for unexpected incidents to take place that require the intervention of personnel specialised in rescue to recover a load, whether it is a person or an object, stuck and/or suspended on a rope. Typically, when these unexpected incidents take place, particularly complex recovery manoeuvres in adverse weather conditions and in a hostile environment are set up, often towards a person in difficulty, injured, unconscious and/or subject to suspension trauma syndrome due to the compression of the femoral arteries and the rib cage, due the posture assumed by the body enclosed in the respective harness.

In such conditions, it is essential to act with the utmost speed, without making mistakes in setting up and configuring the devices necessary to carry out rescue manoeuvres, e.g. those of recovering and lifting from a crevasse or transferring an injured person.

Given the impossibility of determining a priori the conditions in which one will operate, it is therefore necessary to have equipment that is as complete and simple as possible, in order to be able to deal with almost all of the possible situations in which the recovery and rescue manoeuvres will be carried out. For these reasons, the equipment used in rescue operations is particularly bulky and heavy, given the multitude of devices necessary to deal with the different situations that may take place in rescue operations. In fact, especially in rescue operations of a person, it is often necessary to have the equipment necessary to set up a hoist, for moving a load without excessive efforts, and at least one locking/braking device to secure the same load during the moving manoeuvres. In order to solve the problem of acting quickly, having the smallest number of devices necessary to set up all the necessary manoeuvres, while limiting the weight and encumbrance of this equipment, some solutions have been proposed that combine in a single device the characteristics and features of multiple devices that may be needed in rescue operations. In particular, in rescue operations, it may be necessary to quickly set up a sheave system or a hoist, while having a locking/braking device to secure the load to be recovered.

See, e.g., the devices with pulley depicted in patents GB2410235 and FR2339566A1. The devices described in such documents are equipped with a cam mechanism for braking and/or locking a safety rope and with a pulley adapted to facilitate the relative sliding between safety rope and device in the event that it is prepared to set up a sheave or a hoist.

Other examples are provided by the products commercially known by the initials “RM1a”, “RM12a” and “RM22a” produced by the company SRTE (Single Rope Technique Equipment) or by the device called “Block-Roll” marketed by KONG S.p.A. Although particularly appreciated for the versatility and effectiveness in use, said devices have some drawbacks typically related to their size and their use to properly set up the complex manoeuvres necessary in recovery operations.

In fact, in order to be able to correctly and safely perform the manoeuvres necessary for rescue operations, it is necessary to act quickly and not make mistakes in setting up the known devices necessary to perform the manoeuvre. If the rescuer has to combine multiple devices and connect these devices by means of ropes and karabiners, the risk of making mistakes in setting up the equipment and thus compromising its safety increases. Furthermore, in order to combine the functions of multiple devices necessary to set up the numerous manoeuvres, the multifunction devices of known art are considerably bulky which makes them particularly uncomfortable to transport and handle in rescue operations which typically take place in tight gaps.

Furthermore, the presence of a large number of mechanisms makes the known multifunction devices particularly heavy. In order to reduce the weight of said devices, certain structural elements were eliminated during the design and production process, such as, e.g., walls covering the inner path of the safety rope. The absence of said elements, however, poses a risk, in particular with respect to the possibility of the safety rope slipping out of its seat within the multifunction device and, therefore, a potential source of malfunction of the system set up for rescue.

In addition, such devices are inherently particularly complex and complicated to handle. In fact, even in the hands of experienced and trained personnel, the device preparation to set up the configuration of the equipment necessary to perform the recovery operations can be particularly critical. An incorrect configuration of the device would expose not only the load to be recovered, but also the rescue personnel, to the risk of malfunctioning and, in extreme cases, failure of the recovery system and, consequently, fall.

Object of the present invention is therefore to solve the above-mentioned drawbacks of the known art. In particular, object of the present invention is to provide a device equipped with a locking cam as well as a pulley for a safety rope which has a particularly low size and weight, easy to open-install-close by using a single hand, and which at the same time allows to perform several safety and rescue manoeuvres quickly, easily and safely. Further object of the present invention is to provide a device equipped with a locking cam as well as a pulley for a safety rope that does not have problems related to a possible slipping out of the safety rope from the same device.

Another object of the present invention is to provide a device equipped with a locking cam as well as a pulley for safety rope that is particularly easy to use in setting up a recovery system.

Still another object of the present invention is to provide a method of configuring the device that is particularly easy to carry out and safe during the subsequent use of the same device.

### SUMMARY OF THE INVENTION

These and further purposes are achieved by the present invention thanks to a multifunction device equipped with a locking cam as well as a pulley for at least one safety rope according to claim 1 and a method of configuring the multifunction device according to claim 17. Further preferred characteristics and aspects of the invention are provided herein below and/or in the dependent claims.

According to a first aspect, the present invention relates to a multifunction device adapted to house a safety rope.

According to an aspect of the present invention, the multifunction device comprises a first fixed portion. Said first fixed portion comprises a main extension plate and an abutment wall which define therebetween a first passage for said safety rope. Preferably, said abutment wall is a curved wall rising from said plate to define said first passage. According to an embodiment, said abutment wall is configured as a curved wall departing from the main extension plate to define a substantially “U” shape delimiting at least partially said first passage.

According to a further aspect, the multifunction device comprises a first axis of rotation. Said first axis of rotation is constrained to the first portion. Preferably, said first axis of rotation is fixedly constrained to said first portion. Said first axis of rotation extends along a first direction. Still preferably, said first direction and, therefore, said first axis, is perpendicular to said main extension plate.

The multifunction device further comprises a second movable portion with respect to said first fixed portion. Said second portion is connected to said first axis of rotation to rotate around said first direction of extension of the first axis of rotation. Specifically, said second portion is movable in the rotary direction between an open position and a closed position. In the open position, said safety rope may be housed in, i.e. inserted into, or extracted from said multifunction device. In the closed position, on the other hand, the safety rope is contained in said multifunction device so that it cannot slip out of the latter. It should be noted that, in the present document, the term “rotation of an element around a direction of extension of an axis” means a rotation of the element around the axis on which it is mounted with respect to its main extension direction, regardless of the more or less complex shape that the axis may assume in the various embodiments of the multifunction device.

According to a further aspect, the multifunction device comprises a second axis of rotation. Said second axis of rotation is constrained to said first portion. Preferably, said second axis of rotation is fixedly constrained to said first portion. Said second axis of rotation extends along a second direction. Still preferably, said second direction and, therefore, said second axis is perpendicular to said main extension plate.

According to a further aspect of the present invention, the multifunction device comprises a movable cam. Said cam is mounted on said second axis of rotation and is configured to rotate around said second rotation direction. Specifically, said cam is movable in the rotary direction between an interference position with said first passage and a free sliding position. In the interference position, said cam at least partially occupies, i.e. throttles, said first passage so as to push the safety rope, possibly present in said first passage, against said abutment wall, thus obstructing, i.e. braking and/or locking, its sliding within the same first passage. In other words, in the interference position the locking cam is configured to throttle the first passage and, consequently, to lock by throttling the rope present therein. In the free sliding position, said cam does not interfere with said first passage and, therefore, the sliding of the rope possibly housed in said first passage is free, i.e. not obstructed or braked. Furthermore, when said cam is in the free sliding position, it is possible to insert the safety rope into said first passage. Advantageously, the presence of a mobile cam adapted to interfere with the first passage allows to lock or regulate, i.e. manage and, therefore, control the sliding of a safety rope passing through the same first passage. In fact, when said cam is in the interference position, said safety rope is pushed against said abutment wall, i.e. braked and, at the limit, locked by throttling. This way, the multifunction device can be used as a locking/braking device, i.e. as a device for securing a load connected to a branch of the safety rope exiting said first passage.

According to a further aspect, said multifunction device comprises a pulley. Said pulley is mounted on said first axis of rotation to rotate around said first direction. Advantageously, said pulley is shaped, on its outer surface, to accommodate said safety rope. Specifically, said pulley has, on its outer surface, a curved profile configured to house and contain the safety rope. Advantageously, the presence of a pulley allows a reduction of friction with the safety rope and, therefore, an easier sliding of the safety rope within the safety device in relation to some of the manoeuvres that can be performed. Still advantageously, the presence of a pulley allows the multifunction device to be used to set up, with said safety rope, a sheave or a recovery hoist.

According to a further aspect, said device comprises at least one first seat on said first portion and at least one second seat on said second portion. At least when said second portion is in the closed position, said at least one first seat and at least one second seat are configured at least partially coinciding, i.e. they at least partially match, to couple a first connector, e.g. a karabiner, to the multifunction device.

The expression “at least partially coinciding to couple” means that the at least one first seat and the at least one second seat are arranged, i.e., coincide/match, in such a way as to allow the first connector to be combined with the multifunction device, by means of the passage of the same first connector through said at least one first seat and at least one second seat. Accordingly, with reference to said first connector and multifunction device, the term “to couple” means the combination between said elements, e.g. by insertion, or passage, of the first connector through said at least one first seat and at least one second seat.

According to an embodiment, said at least one first seat comprises at least one first hole and said at least one second seat comprises at least one second hole. According to a preferred embodiment, said first seat comprises a first hole and said second seat comprises a second hole. At least when said second portion is in the closed position, said at least one first hole and at least one second hole are at least partially coinciding, i.e. they at least partially match, to couple a first connector, e.g. a karabiner, to said multifunction device.

According to another embodiment, said at least one first seat comprises at least one first loop and/or said at least one second seat comprises a second loop.

It should be noted that the multifunction device may comprise at least one first seat in the form of hole and at least one second seat in the form of loop, or vice versa. Regardless of the embodiment assumed by the at least one first seat and the at least one second seat, it is essential that, at least when said second portion is in the closed position, they are at least partially coinciding, i.e. they at least partially match, to couple a first connector, e.g. a karabiner, to the multifunction device.

Preferably, at least one of said at least one first seat and at least one second seat comprises a hole. Advantageously, the presence of at least one hole ensures a greater structural stability to the multifunction device when a first connector is coupled, e.g. by means of insertion through said at least one first seat and at least one second seat.

In the present document, the term ‘connector’ means any anchoring element having a ring-like profile or, in any case, a closed section (preferably having a movable portion, or length, for the temporary opening of the closed section, e.g. for the insertion of the rope), adapted to be combined with said multifunction device. Typical examples of connectors are the karabiners and anchoring rings, whatever their dimension or shape is.

At least when said second portion is in the closed position, said at least one first seat and at least one second seat are arranged, respectively, on said first portion and second portion, in an area comprised between two straight lines passing through the ends of a segment connecting said first axis of rotation and said second axis of rotation and perpendicular to the same segment. In other words, said at least one first seat and at least one second seat are positioned in an area comprised between two straight lines passing through, respectively, said first axis of rotation and said second axis of rotation. Said straight lines are perpendicular to a segment connecting said first axis of rotation and said second axis of rotation, i.e. they are parallel to each other.

It should be noted that, in the present document, the term “arranged/positioned in an area” means that at least one portion of said at least one first seat and at least one second seat is within the aforesaid area defined by the pair of straight lines. Therefore, said at least one first seat and at least one second seat may be even only partially contained within the aforesaid area. In other words, the perimeters defining the at least one first seat and the at least one second seat are either entirely contained in the aforesaid area or intersect the straight lines which define the same area.

Preferably, at least when said second portion is in the closed position, said at least one first seat and at least one second seat are arranged in a sub-area of the aforesaid area defined by the straight lines passing through the ends of the segment which connects the first axis and the second axis and by an additional pair of straight lines perpendicular to the aforesaid straight lines and tangent to the outer profile of the pulley.

According to an embodiment, at least when said second portion is in the closed position, said at least one first seat and at least one second seat are arranged along a segment which links said first axis of rotation and said second axis of rotation. In other words, the perimeters defining said at least one first seat and at least one second seat are at least partially intersected by said segment which links said first axis and said second axis. It should be noted that the term “arranged along a segment” means any position along said segment, including ends. This means that said first and second seats may be arranged at said first axis, said second axis or any intermediate position between said axes. Therefore, said at least one first seat and at least one second seat occupy a central, and not a peripheral, position in said multifunction device. Advantageously, the positioning of the at least one first seat and the at least one second seat allow to keep the dimensions, and consequently also the weight, of the multifunction device small, as well as to allow the set-up and functionality of the respective manoeuvres.

According to an aspect of the present invention, at least when said second portion is in the closed position, said first and second portions define one or more of the following passages (preferably two or more of the following passages are present, more preferably all of the following passages are present):
a second closed passage for said safety rope, which is opposite the first passage with respect to said second axis of rotation (i.e., said first passage and second passage are on opposite sides with respect to the second axis of rotation or, similarly, the second axis of rotation is interposed between said first passage and second passage);
a third closed passage for said rope between said cam and said pulley;
a fourth passage for said rope with said pulley, which is opposite said third passage with respect to said first axis of rotation and which at least partially corresponds with said pulley (i.e., said third passage and fourth passage are on opposite sides with respect to the first axis of rotation or, similarly, the first axis of rotation is interposed between said third passage and fourth passage).

Moreover, when said second portion is in the closed position, it also closes, in combination with said cam, the first passage defined between the plate and the abutment wall of the first portion.

In particular, the second passage is opposite the first passage with respect to the segment which links said first and second axes of rotation. That is, said first passage and second passage are on opposite sides with respect to said segment or, similarly, said segment is interposed between said first passage and second passage.

Analogously, said fourth passage is also opposite said third passage with respect to the straight line passing through the first axis and perpendicular to the segment which links said first axis and second axis. In other words, said straight line passing through the first axis and perpendicular to the segment which links said first axis and second axis is interposed between said third passage and said fourth passage.

As will become clearer hereinafter in the present description, during the operations of configuring the multifunction device, in order to perform the various manoeuvres, the safety rope is inserted into at least one of the paths (or passages) defined between said first and second portions, when the latter is in the open position. Advantageously, when the second portion is in the closed position, i.e. in the position of use of the multifunction device, the presence of multiple closed paths minimises, or even eliminates, the possibilities of the safety rope slipping out of the same device. In fact, it is essential for the correct operation of the multifunction device that the safety rope remains in position within the passages in which it is positioned. In fact, an incorrect displacement of the rope in the multifunction device could cause malfunctions and, therefore, could expose the load connected to it to the risk of falling.

According to a preferred embodiment, the second axis can be reversibly engaged with said second movable portion. In particular, said second axis of rotation comprises a restraining system configured to keep said second portion in said closed position. Said restraining system is operable to bring said second portion into said open position. In other words, when the second portion is in said closed position, it is kept in position by said restraining system. If it is necessary to bring the second portion into the open position, e.g. to insert or extract a safety rope, said restraining system may be operated to bring said second portion into the open position. Once the second portion has been brought back into the closed position, the restraining system will keep the aforesaid second portion in the closed position until the next operation.

Advantageously, the presence of a restraining system for the second portion ensures a constraint between the first portion and the second portion and a structural unit of the multifunction device, wherein the second portion, once brought into the closed position, keeps its position unless the restraining system is activated voluntarily. This way, the risks of opening the second movable portion and the consequent malfunction dangers related to the safety rope slipping out of the multifunction device are minimised.

Preferably, said restraining system comprises a spring-loaded button adapted to be operated to allow the passage of the second portion from the closed position to the open position. Said spring-loaded button is configured, in idle condition, to remain exposed and to abut said second portion when it is in the closed position, thus preventing it from switching to the open position. In order to bring the second portion into the open position, the spring-loaded button can be operated so that the second portion can be brought into the open position without the resistance given by the abutment of the spring-loaded button. Advantageously, the presence of a spring-loaded button provides a restraining system that is effective and can be easily operated even by an operator acting in critical situations.

According to a further aspect, said movable cam comprises an increased friction surface for contacting said safety rope in said first passage when said cam is in an interference position. In a preferred embodiment, said friction surface is a toothed surface. According to other embodiments, said increased friction surface is a knurled surface.

Advantageously, the presence of an increased friction surface allows a more effective and immediate braking/locking action on the safety rope since any sliding of the rope within the first passage, when the cam is in the interference position, is minimised.

Preferably, said cam comprises a return element configured to return said cam to an interference position. According to an embodiment, said return element is a spiral spring having an idle condition coinciding with the interference position of said locking cam, i.e., of pressure of the cam towards the abutment wall.

Advantageously, the presence of a return element ensures that the locking cam's idle position is the interference position and, therefore, that the cam does not stay in the free sliding position when not necessary. In other words, the locking cam naturally stays in interference position. According to an aspect, in order to bring the locking cam into the free sliding position, it is necessary to operate on the rope, i.e. to exert traction, in a suitable direction to overcome the action of the return element. By operating on the rope in the opposite direction or interrupting the action that brought the cam into the free sliding position, the same cam returns to the interference position.

Still preferably, said locking cam comprises a manual control device configured to move said cam between said interference position and said free position. In particular, said control device is configured to allow a movement of the locking cam even in the absence of tension on the rope placed in the first passage. For example, said manual control device is configured to overcome the return force exerted by the return element and to bring the cam into the free sliding position in the absence of forces on the safety rope, or in the presence of tensions that would have the effect of bringing the cam into the interference position. According to an embodiment, said manual control device comprises a string operatively connected to the locking cam. According to another embodiment, said manual control device comprises a control lever connected to said locking cam. Advantageously, the presence of a manual control device allows a more flexible and easier handling of the sliding of the safety rope.

Preferably, the multifunction device comprises a first end stop. Said first end stop is configured to limit the rotation of the cam when it is in the interference position. In other words, the first end stop ensures that the rotation of the cam is limited, in a first direction of rotation, by the interference position. According to a preferred embodiment, said first end stop is a pin constrained to said first portion. In other embodiments, the first end stop is constrained to other components of the multifunction device, e.g. the second portion. Still preferably, the multifunction device comprises a second end stop. Said second end stop is configured to limit the rotation of the cam when it is in the free sliding position. In other words, the second end stop ensures that the rotation of the cam is limited, in a second direction of rotation opposite the aforesaid first direction of rotation, by the free sliding position. According to a preferred embodiment, said second end stop is a pin constrained to said second portion. Advantageously, the positioning of the second end stop on the second portion allows, when the second portion is in the open position, to further rotate the locking cam beyond the free sliding position in order to allow an easier insertion of the safety rope into the first passage. In other embodiments, the second end stop is constrained to other components of the multifunction device, e.g. the first portion. Advantageously, the presence of said first stop and/or said second end stop ensures, at least when the second portion is in the closed position, that the rotation of the cam is limited and, therefore, that it does not have to overcome angles that are too wide in order to act in the desired position. Consequently, a rapid response of the multifunction device to the conditions of the safety rope is ensured and interference between the cam and other elements of the device, which could be a source of inefficiencies in operation during the execution of certain manoeuvres, is precluded.

According to a further aspect, the at least one first seat has an extension smaller than the at least one second seat, i.e. the at least one first seat covers, on said first portion, an area smaller than the area covered by the at least one second seat on the second portion. Advantageously, the smaller area of the first seat ensures that the first connector, which is coupled to said multifunction device, e.g. by means of the insertion through said first and second seats, is in contact mainly with the perimeter defining the first seat. This way, the weight and forces exchanged between the multifunction device and the aforesaid first connector are mainly transferred to the first portion of the multifunction device.

According to an embodiment, said at least one first seat and at least one second seat are positioned in a central portion of said segment which links said first axis of rotation and said second axis of rotation. In other words, said first and second seats are not positioned in the end positions of the aforesaid segment, i.e. they are not positioned at said first axis and second axis and are therefore at a distance from said first and second axes. In this embodiment, said first and second seats at least partially coincide when said second portion is in the closed position, whereas they do not coincide when the second portion is in the open position.

According to another embodiment, the at least one first seat and the at least one second seat are positioned at said first axis of rotation or second axis of rotation, i.e. at the ends of the aforesaid segment which links said first axis of rotation and said second axis of rotation. In this embodiment, said first axis of rotation or second axis of rotation are hollow in order to allow the passage of a connector through said first and second seats. Preferably, said first and second seats are positioned at the first axis of rotation and, therefore, said first and second seats coincide regardless of the position assumed by the second portion with respect to the first portion.

According to a further aspect, said first portion and second portion comprise respective flaps configured to close, with said cam, said second passage when said second portion is in the closed position. Said flaps are configured as lips which depart from the main extension surfaces of said first and second portions and which, when said second portion is in the closed position, face at such a distance as to prevent the passage of a safety rope possibly housed within the second passage. This way, the second passage is closed between the first portion, the second portion and the locking cam. Thus, advantageously, a safety rope possibly present within the second passage cannot slip out therefrom unless the second portion is moved to an open position.

Preferably, said first portion and second portion comprise, at their respective perimeter edges, at least one indentation configured for supporting a further connector when said second portion is in the closed position and the rope is kept in its respective seat. It should be noted that the further connector is not the same first connector intended to be coupled to said multifunction device through said at least one first seat and at least one second seat. Said indentation is represented by a concavity shaped in the outer profile of the first portion and the second portion. This indentation is adapted to allow the housing of said further connector, which is substantially positioned around said first and second portions in order to at least partially contain them, as will become clearer hereinafter in the present description with reference to FIGS. 10 and 11. Specifically, said further connector is configured to be housed before or after the coupling of the first connector through said at least one first seat and at least one second seat. In this situation, the further connector is substantially contained within said indentation by said first connector and said first and second portions. Said further connector is configured to be interposed, at said indentation, between the safety rope and the outer perimeter of said first and second portions. Advantageously, the presence of the further connector interposed between the safety rope and the multifunction device ensures more precise handling of the movements of the load secured to the safety rope, especially during the rappelling operations of a load.

Said multifunction device is preferably made of metal material, even more preferably of metal material with high mechanical characteristics and low weight, e.g. steel, aluminium or equivalent materials/alloys.

Further object of the present invention is a method of configuring the multifunction device just described for accommodating at least one safety rope and setting up manoeuvres, e.g. rescue and/or recovery manoeuvres.

According to a first aspect, said configuration method comprises the following main steps:
opening said multifunction device by bringing said second portion into the open position;
housing at least one safety rope in at least one closed passage comprised between said first portion and said second portion;
closing said multifunction device by bringing said second portion into the closed position in such a way that said rope remains in the gap between said first portion and said second portion.

Advantageously, housing said safety rope within at least one passage intended to be closed when the multifunction device is in an operative condition, i.e. when said second portion is in the closed position, ensures high safety during the use of the same device. In fact, closing the at least one passage between said first and second portions prevents the rope from slipping out of the device and ensures high safety of use of the multifunction device. Furthermore, the proposed method is considerably simple to carry out since the opening of the first portion ensures that the correct insertion of the rope into the device is particularly easy.

In an embodiment of the configuration method, the step of housing said safety rope provides for housing said rope in said first passage. In this embodiment, the configuration method also comprises a step of coupling said first connector to the device through said at least one first seat and at least one second seat. Preferably, the first connector is not crossed by the safety rope, i.e. the rope passes outside the first connector. In this embodiment, the multifunction device is used as simple locking device. When the safety rope slides in one direction within the multifunction device, the locking cam is brought into the interference position and the sliding of the rope is stopped, thus interrupting the movement, e.g. the descent, of a load connected to an end of the rope. When the safety rope slides in the opposite direction within the multifunction device, the locking cam is brought into the free sliding position to allow the movement, e.g. the lifting, of the load connected to an end of the rope.

In another embodiment of the configuration method, the step of housing said safety rope provides for housing said rope in said first passage, in a fourth passage and a second passage. Specifically, said second passage is opposite said second axis of rotation with respect to the first passage and the fourth passage is partially coinciding with said pulley. In this embodiment, the configuration method also comprises a step of coupling said first connector to said multifunction device through said at least one first seat and at least one second seat. Preferably, the first connector is crossed by said rope, i.e. the rope is passing within the section of the first connector. In this embodiment, the multifunction device can be used as a device for securing a load connected to an end of the rope exiting the first passage, e.g. in rescue operations of a climber in difficulty. In this configuration, when the rope is subjected to tension due to the weight force of the load, the cam is brought into the interference position to brake/lock the descent of the load. By acting on a second end of the rope exiting the second passage, it is possible to exert a tensile force sufficient to overcome the weight force of the load, consequently, bring the cam into the free sliding position and lift the load. This action on the second end of the rope, when carried out by a person weighing on the first end or when the first end is secured to an anchorage and the connector to the load to be lifted, takes place with half the effort compared to direct lifting, net of frictions. By interrupting the traction, the cam is returned to the interference position and the rope slide in the device is again braked/locked.

According to an aspect, in this embodiment, the safety rope passing through said first passage, fourth passage and second passage, follows an overall path having substantially a “U” shape. In particular, the branches of the “U” shape of the path of the aforesaid rope consist of the first passage and the second passage, respectively. According to this aspect of the invention, the at least one first seat and the at least one second seat are arranged within the rope path (which, as mentioned, has substantially a “U” shape) formed by the aforesaid first passage, fourth passage and second passage.

Preferably, in this embodiment, the configuration method provides, either prior or subsequent to the step of housing said rope, for a step of housing said further connector in said indentation. Once the safety rope has been inserted, said further connector is interposed, at said indentation, between the perimeter edge of the first and second portions and the same safety rope. Advantageously, the presence of the further connector in said indentation allows to optimally transfer the weight force of the load to be secured and to facilitate the load rappelling operations. Specifically, the housing of the further connector allows to carry out a more controlled rappel of the secured load.

According to another embodiment of the configuration method, the step of housing said safety rope provides for housing said rope in said third passage. In other words, in said embodiment, the safety rope is housed in a gap closed between said first portion, said second portion, said locking cam and said pulley. In particular, the safety rope is in contact with said pulley to allow relative sliding between the same safety rope and the multifunction device. In this embodiment, the configuration method comprises a step of coupling the first connector to said multifunction device through said at least one first seat and said at least one second seat. For example, said first connector may not be crossed by said safety rope to set up a sheave.

According to yet another embodiment of the configuration method, the step of housing said safety rope provides for housing a first branch of said rope in said first passage and a second branch of said rope in the third passage closed between said cam and said pulley. It should be noted that said first branch and said second branch may be distinct sections of the same safety rope and not two distinct safety ropes. In particular, between said first branch and second branch a load to be secured is positioned, e.g. by means of a connector. In this embodiment, the multifunction device can be used to set up a recovery hoist, possibly with multiplying gear, to move a load to be recovered with a favourable force ratio.

It is further an object of the present invention a multifunction system comprising the multifunction device described above and at least one safety rope. According to an aspect, said multifunction system is set up in accordance with the configuration method explained above. Preferably, said multifunction system comprises at least one first connector. Everything described or claimed with respect to the multifunction device and the respective configuration method applies to the aforesaid multifunctional system.

### BRIEF DESCRIPTION OF THE FIGURES

Further aspects and advantages of the present invention will become clearer from the following description given by way of example with reference to the accompanying schematic drawings, in which:

FIG. 1 depicts a rear view of an embodiment of the multifunction device in accordance with the present invention;

FIG. 2 depicts a sectional view according to the B-B sectional plane of the multifunction device in FIG. 1;

FIGS. 3A and 3B respectively depict a front view and a rear view of the multifunction device of FIG. 1 in open position;

FIG. 4 depicts a front view of the multifunction device in FIG. 3A in another embodiment and with the cam fully open;

FIG. 5 depicts a front view of the multifunction device in FIG. 1 with some elements removed for more clarity;

FIG. 6 depicts a rear view of the multifunction device in FIG. 5;

FIG. 7 depicts an exploded view of the multifunction device of FIG. 1;

FIG. 8 depicts the multifunction device in FIG. 1 in use according to a first configuration;

FIG. 9A depicts the multifunction device in FIG. 1 in use according to a second configuration;

FIG. 9B depicts the multifunction device of FIG. 9A with some inner details depicted by means of dashed lines for more clarity;

FIG. 9C depicts the device according to the configuration of FIG. 9A in a different mode of use;

FIG. 10 depicts the multifunction device in FIG. 1 in use according to a third configuration;

FIG. 11 depicts the multifunction device of FIG. 10 with some inner details depicted by means of dashed lines for more clarity;

FIG. 12 depicts the multifunction device in FIG. 1 in use according to a fourth configuration;

FIG. 13 depicts the multifunction device in FIG. 1 in use according to a fifth configuration;

FIGS. 14A-C depict the device according to the configuration of FIG. 13 in different modes of use;

FIG. 15 depicts a front view of another embodiment of the multifunction device in accordance with the present invention.

### DESCRIPTION OF SOME EMBODIMENTS

With reference to the accompanying figures, a multifunction device equipped with a locking cam as well as a pulley for at least one safety rope F in different configurations and embodiments, in accordance with the present invention, has been denoted by the reference 100. Hereinafter in the present description, the multifunction device will be referred to as device 100 for simplicity. It should be immediately noted that similar elements of the various embodiments will be denoted in the accompanying figures with the same reference numerals.

What is described below refers to the device 100 in a version of the device 100, referred to as “right” in the jargon. It should be understood that the same may be applied to the version referred to as “left” in the jargon, which is substantially equivalent to a mirror version of device 100 in the arrangement of the components. What is described herein with respect to the “clockwise” and “counterclockwise” directions of rotation should be understood in the opposite direction in the mirror configuration of the device 100.

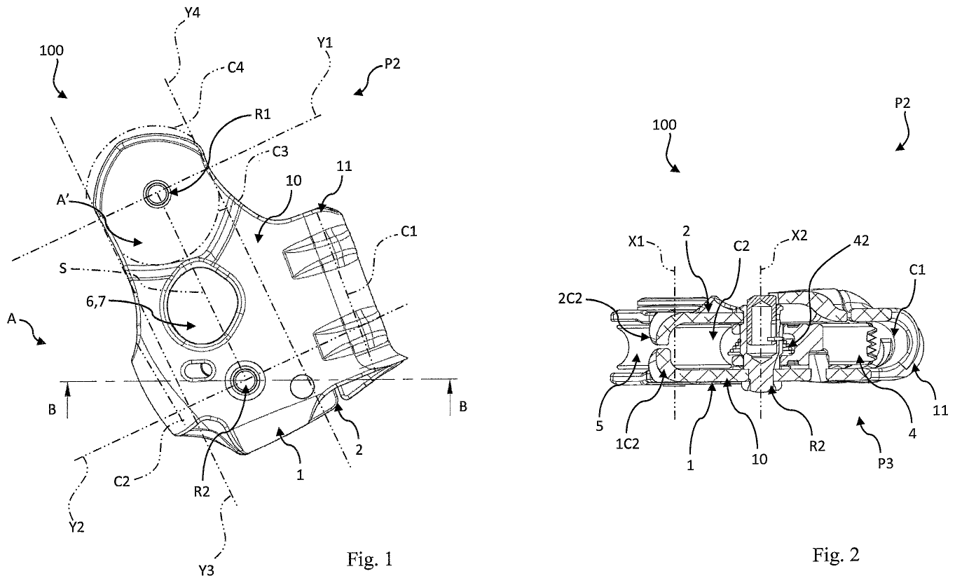

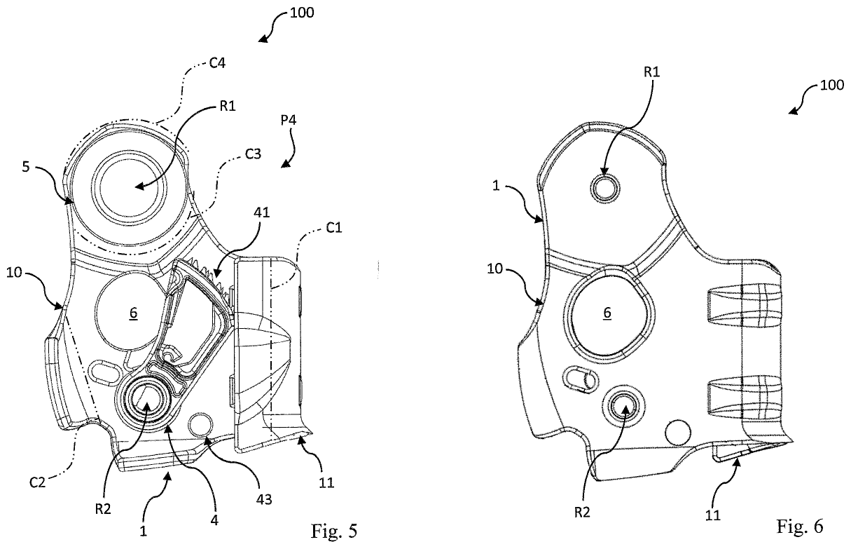

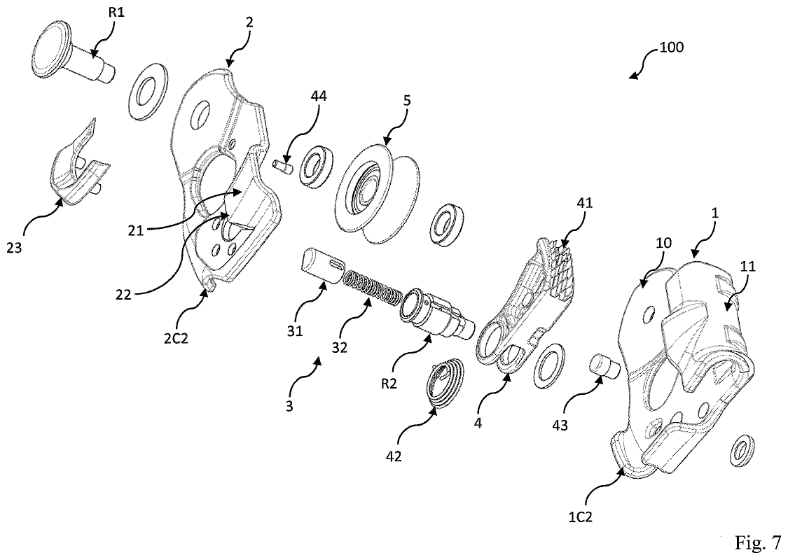

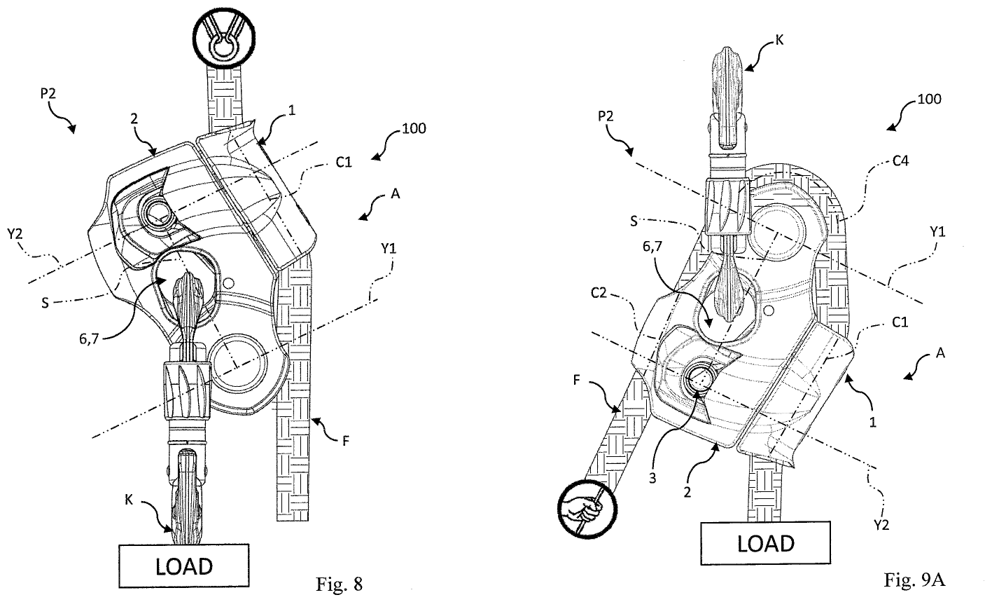

With reference to FIG. 1, the device 100 comprises a first fixed portion 1. Said first portion 1 is depicted in greater detail in FIGS. 5 and 6. According to what is depicted, said first portion 1 comprises a main extension plate 10 and an abutment wall 11. Said plate 10 and abutment wall 11 define a first passage C1 for said rope F. Said first passage C1 is configured to house said rope F as depicted e.g. in FIGS. 8 to 11 and 13-14.

In the embodiments depicted in the attached figures and in more detail in FIG. 2, said abutment wall 11 is shaped as a curved wall departing from the plate 10 to define a substantially U-shaped form which at least partially delimits said first passage C1 to house said rope F.

The device 100 comprises a first rotation axis R1 constrained, preferably in a fixed manner, to said first portion 1. Said first axis R1 extends along a first direction X1. According to what is depicted e.g. in FIG. 7, said first axis R1 comprises a pin fastened to said first portion 1 and extending along the first direction X1. Preferably, as depicted in FIG. 2, said first direction X1, and therefore said first axis R1, is perpendicular to said first portion 1, in particular to said main extension plate 10.

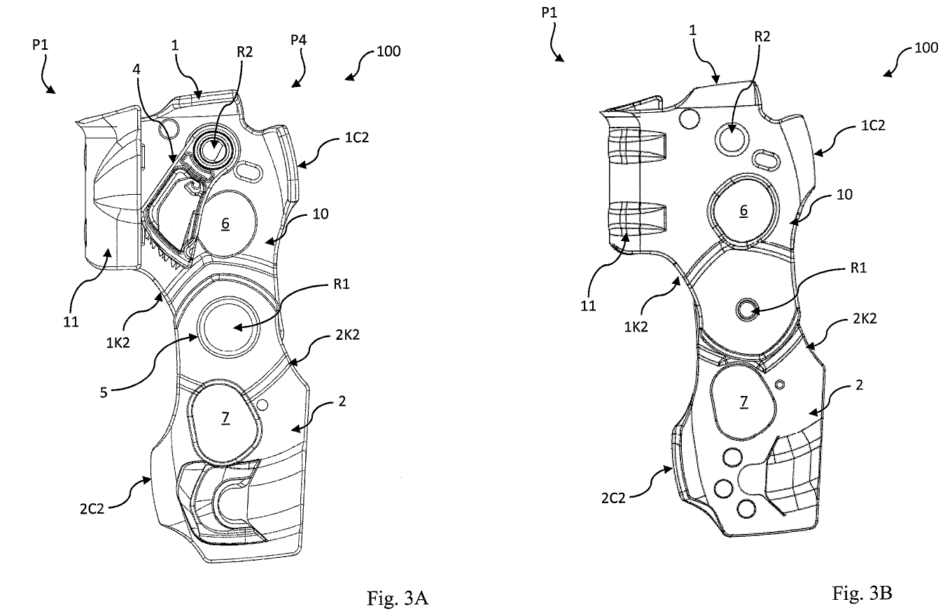

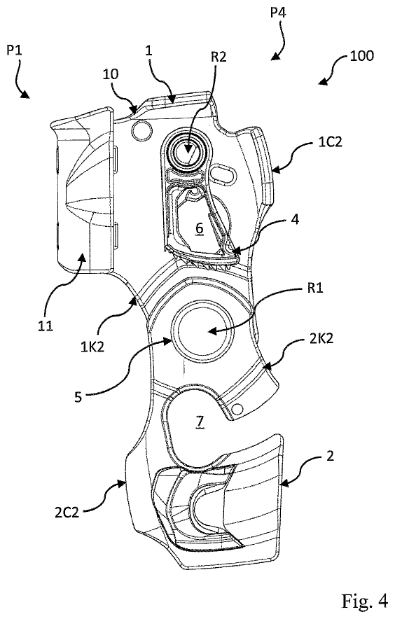

According to what is depicted, the device 100 comprises a second portion 2. Said second portion 2 is movable with respect to said first portion 1. In particular, said second portion 2 is connected to said first axis R1 to rotate around said first direction X1. Specifically, said second portion 2 is movable in the rotary direction between an open position P1 depicted, e.g., in FIGS. 3A, 3B and 4, and a closed position P2 depicted, e.g., in FIGS. 1, 2 and 8-15. In the open position P1, said rope F may be housed in, i.e. inserted into or extracted from said device 100. In the closed position P2, on the other hand, the rope F is contained in said device 100 so that it cannot slip out of the latter. With reference to the perspective of FIGS. 3A, 4, 8, 9, 11-14, the switching of the second portion 2 from the open position P1 to the closed position P2 coincides with a partial counterclockwise rotation of the same second portion 2 around the first axis of rotation R1. With reference to the aforesaid figures, the switching of the second portion 2 from the closed position P2 to the open position P1 coincides with a partial clockwise rotation of the same second portion 2 around the first axis of rotation R1.

The device 100 further comprises a second axis R2 of rotation. Said second axis R2 is constrained to said first portion 1. Preferably, said second axis R2 is fixedly constrained to said first portion 1. As depicted in detail in FIG. 2, the second axis R2 extends along a second direction X2. According to what is depicted e.g. in FIG. 7, said second axis R2 comprises a pin fastened to said first portion 1 and which extends along the second direction X2. In the depicted embodiments, said second direction X2 and, therefore, said second axis R2 is perpendicular to said first portion 1, in particular to said main extension plate 10.

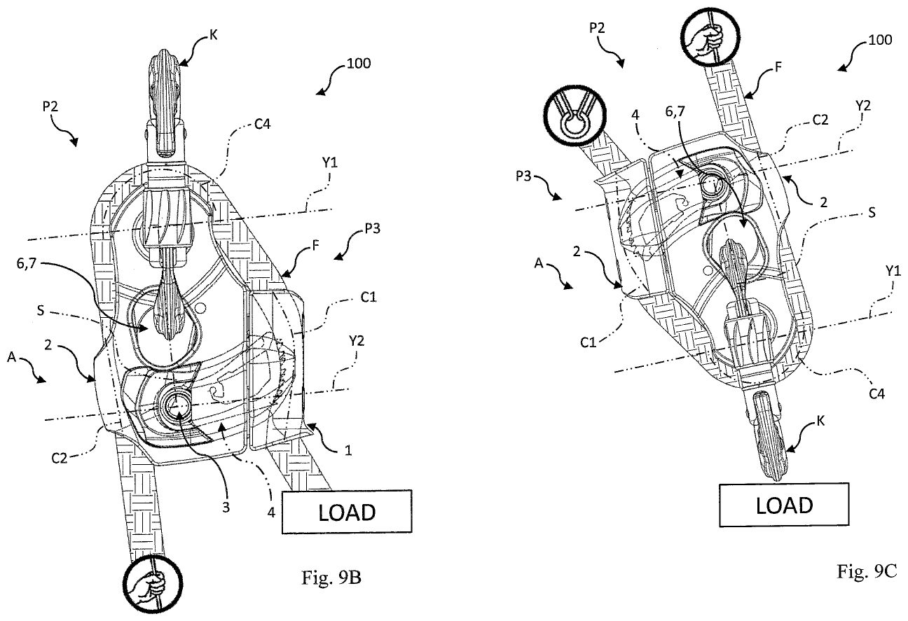

The device 100 comprises a movable cam 4. As depicted e.g. in FIG. 5, said cam 4 is mounted on said second axis R2 and is configured to rotate around said second direction X2. Specifically, said cam 4 is movable in the rotary direction between an interference position P3 with said first passage C1, which is depicted e.g. in FIGS. 2 and 9B, and a free sliding position P4 depicted in FIGS. 3A, 4, 5 and 11. As depicted in the configuration of FIG. 2 and FIG. 9B, when said cam 4 is in the interference position P3, it occupies at least partially said first passage C1. With reference to the perspective of FIGS. 3A, 4, 8, 9, 11-14, the switching of the cam 4 from the interference position P3 to the free sliding position P4 coincides with a partial counterclockwise rotation of the same cam around the second axis of rotation R2. With reference to the same figures, the switching of the cam 4 from the free sliding position P4 to the interference position P3 coincides with a partial clockwise rotation of the same cam around the second axis of rotation R2.

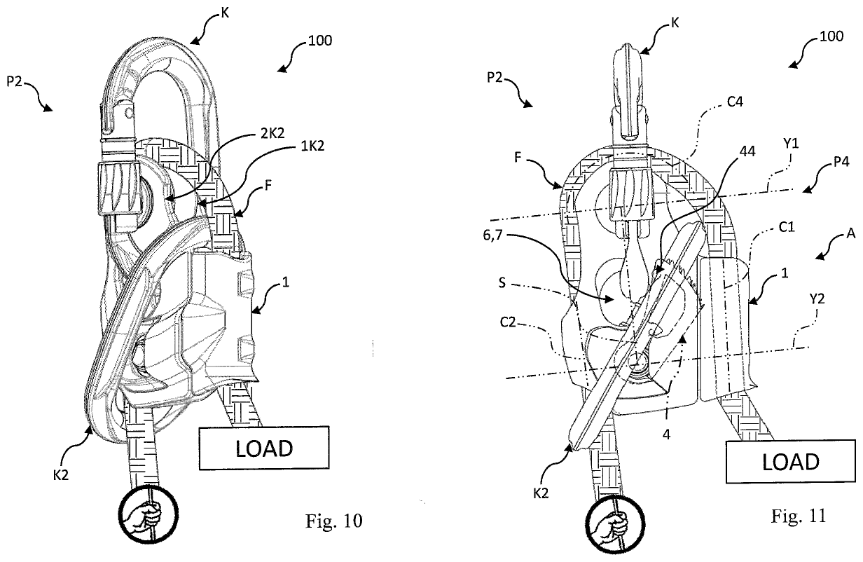

In the aforesaid interference position P3 depicted e.g. in FIG. 9B, the rope F present in the first passage C1 is pushed by the cam 4 against said abutment wall 11 and its sliding within the first passage C1 is obstructed, i.e. braked or preferably locked. On the contrary, according to what is depicted in the configuration of FIG. 11, when said cam 4 is in the free sliding position P4, said cam 4 does not interfere with said first passage C1 and, therefore, the sliding of the rope F housed in said first passage C1 is free, i.e. not obstructed or braked. Therefore, the cam 4 is configured to regulate, i.e. manage the locking or sliding of the rope F passing through the first passage C1. Moreover, as depicted in particular in FIG. 4, when said cam 4 is in the free sliding position P4 and said second portion 2 is in the open position P1, it is possible to insert/extract the rope F into/from said first passage C1.

In accordance with what is depicted in the accompanying figures, the device 100 comprises a pulley 5. Said pulley 5 is mounted on said first axis R1 to rotate around said first direction X1. As can be appreciated in FIGS. 2 and 7, said pulley 5 is shaped, on its outer surface, to accommodate said rope F. Specifically, said pulley 5 has, on its outer surface, a curved profile configured to house and contain the rope F.

The device 100 then comprises at least one first seat 6 positioned on said first portion 1 and at least one second seat 7 on said second portion 2. In the depicted embodiments, the device 100 comprises a single first seat 6 and a single second seat 7. In the present description, reference will therefore be made to the depicted embodiments in which there is only one first seat 6 and only one second seat 7. However, embodiments with multiple first seats 6 and second seats 7 should be understood as being part of the present invention, and what was mentioned in relation to the depicted embodiments also extends to the case where the device 100 is equipped with multiple first seats and second seats.

According to an embodiment depicted in FIGS. 1-3B and 5-15, said first seat 6 comprises a first hole 6 and said second seat 7 comprises a second hole 7. In other words, according to this embodiment, the first portion 1 and the second portion 2 have, on their respective surfaces, a through hole whose perimeter is entirely contained by the corresponding surfaces.

According to another embodiment, said first seat 6 comprises a first loop, or concavity, 6 and/or said second seat 7 comprises a second loop, or concavity, 7. In other words, in this embodiment, the first portion 1 and/or the second portion 2 have a recess along their outer profile.

It should be noted that, as depicted in FIG. 4, said first seat 6 and second seat 7 may take mixed shapes, i.e. one may comprise a hole and the other may comprise a loop or concavity, as depicted, e.g., in the embodiment of FIG. 4, in which the first seat 6 is a through hole and the second seat 7 is a loop.

Hereinafter in the present invention reference will be made to the first seat 6 as the first hole 6 and to the second seat 7 as the second hole 7, since the embodiments depicted in FIGS. 1-3B and 5-15 comprise only holes. However, it should be understood that what is mentioned with reference to the first hole 6 and the second hole 7 may be transposed to the first loop 6 and/or the second loop 7 or, more generally, to the first seat 6 and the second seat 7.

As depicted, e.g., in FIGS. 8 and 9A-C, at least when the second portion 2 is in the closed position P2, the first hole 6 and the second hole 7 are at least partially coinciding, i.e. they at least partially match, for coupling a first connector K to said device 100. In the accompanying figures, the first connector K is depicted in the form of a karabiner. However, as previously mentioned in the present document, the term “connector” means any anchoring element having a ring-like or, in any case, closed profile (preferably having a movable portion, or length, for the temporary opening of the closed section, e.g. for the rope insertion) adapted to be combined with said device 100 at said first hole 6 and second hole 7.

As still depicted in FIG. 1, at least when said second portion 2 is in the closed position P2, said first hole 6 and second hole 7 are arranged in an area A comprised between two straight lines Y1, Y2 passing through the ends of a segment S which links said first axis R1 and said second axis R2. Said straight lines Y1, Y2 are perpendicular to said segment S and are consequently parallel to each other. Specifically, as depicted in FIG. 1, the straight line Y1 is passing through the first axis R1 and the straight line Y2 is passing through the second axis R2.

It should be noted that, in the present document, the term “arranged/positioned in an area” means that at least one portion of said first hole 6 and second hole 7 is within the aforesaid area A defined by the pair of straight lines Y1, Y2. Therefore, said first hole 6 and second hole 7 may also be only partially contained within the aforesaid area A. In other words, the perimeters defining said first hole 6 and second hole 7 are either entirely contained within the aforesaid area A or intersect the two straight lines Y1, Y2 passing through the ends of the segment S.

Preferably, as depicted in FIG. 1, at least when said second portion 2 is in the closed position P2, said first hole 6 and second hole 7 are arranged in a sub-area A′ of the area A. This sub-area A′ is comprised between the two straight lines Y1, Y2 and an additional pair of straight lines Y3, Y4 perpendicular to the aforesaid straight lines and tangent to the outer profile of the pulley 5. Said sub-area A′ is therefore configured as a rectangle comprised between the straight lines Y1, Y2 and the two additional straight lines Y3, Y4. According to the embodiments depicted in the attached figures, at least when said second portion 2 is in the closed position P2, said first hole 6 and second hole 7 are arranged along the segment S which links said first axis R1 and said second axis R2. In other words, the perimeters defining said first hole 6 and second hole 7 are at least partially intersected by said segment which links said first axis R1 and said second axis R2. It should be noted that the term “arranged along a segment” means any position along said segment, including ends. With reference to the embodiment of FIGS. 1-14, said first hole 6 and second hole 7 may be arranged at an intermediate position between said first axis R1 and second axis R2. In the embodiment of FIG. 15, said first hole 6 and second hole 7 are arranged at an end of said segment, in this case at the first axis R1 which, therefore, is hollow in this embodiment.

As depicted in FIG. 1 and partially in FIGS. 2, 8, 9A-C and 11-15, when said second portion 2 is in the closed position P2, said first and second portions define at least one of the following passages, preferably a combination of two or more of the following passages, more preferably all of the following passages:
a second passage C2 closed for said rope F and opposite said first passage C1 with respect to said second axis R2 (i.e., said first passage C1 and second passage C2 are on opposite sides with respect to said second axis R2 or, similarly, the second axis R2 is interposed between said first passage C1 and second passage C2);
a third passage C3 closed for said rope F between said cam 4 and said pulley 5;
a fourth passage C4 for said rope F at least partially coinciding with said pulley 5 and opposite the third passage C3 with respect to said first axis R1 (i.e., said third passage C3 and fourth passage C4 are on opposite sides with respect to said first axis R1 or, similarly, the first axis R1 is interposed between said third passage C3 and fourth passage C4).

Furthermore, as can be appreciated from FIG. 2, when it is in the closed position P2, said second portion 2 closes, in combination with said cam 4, also the first passage C1 and, therefore, prevents the rope F from slipping out of the device 100.

In particular, the second passage C2 is opposite the first passage C1 with respect to the segment S linking said first axis R1 and second axis R2. In other words, said first passage C1 and second passage C2 are on opposite sides with respect to said segment S or, similarly, said segment S is interposed between said first passage C1 and second passage C2.

Similarly, said fourth passage C4 is also opposite said third passage C3 with respect to the straight line Y1 passing through the first axis R1 and perpendicular to segment S. In other words, said straight line Y1 is interposed between said third passage C3 and said fourth passage C4.

During the use of the device, which will be described in more detail below with reference to the attached figures, said rope F is housed in at least one of said first passage C1, second passage C2, third passage C3 and fourth passage C4.

In the depicted embodiments, the second axis R2 can be reversibly engaged with said second portion 2. In particular, said second axis 2 comprises a restraining system 3. Said restraining system 3 is configured to keep said second portion 2 in said closed position P2. Specifically, the restraining system 3 can be operated to bring said second portion 2 into said open position P1. In other words, when the second portion 2 is in the closed position P2, it is kept in position by said restraining system 3. If it is necessary to bring the second portion 2 in the open position P1, e.g. to insert or extract said rope F, said restraining system 3 is operated to bring said second portion 2 into the open position P1. Once the second portion 2 is brought back into the closed position P2, the restraining system 3 keeps the aforesaid second portion 2 in the closed position P2 until the subsequent operation of the same restraining system.

Preferably, said restraining system 3 comprises a spring-loaded button composed of a button 31 and a spring 32 depicted in more detail in the exploded view of FIG. 7. Said spring-loaded button is configured to be operated and to allow the second portion 2 to switch from the closed position P2 to the open position P1. In the idle condition, the spring 32 pushes towards said button 31 along the second direction X2 so that the button 31 can abut a wall of the second portion 2 when it is in the closed position P2, thus preventing it to switch to the open position P1. In order to allow the second portion 2 to switch to the open position P1, the button 31 is pressed and the spring 32 is compressed and the second portion 2 can be moved into the open position P2 without the resistance given by the abutment with the button 31.

As depicted in FIG. 7, the second portion 2 comprises chute shaping 21 ending with an abutment wall 22 at the area adapted to contact the button 31. This chute shaping 21 allows the second portion 2 to be brought from the open position P1 to the closed position P2 without operating the button 31. In fact, by bringing the second portion 2 into the closed position P2, the chute shaping 21 abuts the button 31 by gradually compressing the spring 32. Once the abutment wall 22 has been passed, the button 31 is released and the spring 32 moves to its idle condition. The abutment between the abutment wall 22 and the button 31 advantageously prevents the second portion 2 from switching, unless the button 31 is operated again.

In the depicted embodiment, the second portion 2 also comprises a safety cover 23. Said safety cover 23 is configured to cooperate with the button 31 and to prevent the inadvertent operation of the button 31. Furthermore, said safety cover 23 is shaped to ergonomically abut an operator's finger while operating the button 31. Specifically, the safety cover 23 is adapted to allow the button 31 to be operated only by an action substantially parallel to the second direction X2. In other words, the safety cover 23 prevents the accidental contact with the button 31 from operating the restraining system 3 and allowing the undesired switching of the second portion 2 from the closed position P2 to the open position P1.

As depicted in the attached figures, said cam 4 comprises an increased friction surface 41 for maximising the friction with said rope F in said first passage C1 when said cam 4 is in the interference position P3. In the depicted embodiment, said increased friction surface 41 is a toothed surface. According to other embodiments not depicted, said increased friction surface 41 is a knurled surface.

In accordance with what is shown in FIGS. 2 and 7, the cam 4 further comprises a return element 42 configured to return said cam 4 to the interference position P3. In the depicted embodiment, said return element 42 is a spiral spring having an idle condition coinciding with the interference position P3 of said cam 4.

Preferably, the cam 4 comprises a manual control device not depicted in the accompanying figures and configured to move said cam 4 between said interference position P3 and said free position P4. In particular, said return control is configured to allow a movement of the cam 4 also in the absence of tension on the rope F placed in the first passage C1. According to an embodiment, said manual control device comprises a string operatively connected to cam 4. According to another embodiment, said manual control device is a control lever operatively connected to said cam 4.

As depicted in the embodiments of the attached figures, the device 100 comprises a first end stop 43 and a second end stop 44. Purpose of said first stop 43 and second stop 44 is to limit the rotation of the cam 4.

Specifically, the first stop 43 is configured to limit the rotation of the cam 4 when it is in the interference position P3. With reference to, e.g., the perspective of FIG. 5, the first stop 43 ensures that the clockwise rotation of the cam 4 is limited by the interference position P3. In the depicted embodiment, said first stop 43 is a pin constrained to said first portion 1. In other embodiments, the first stop 43 is constrained to other components of the device 100, e.g. the second portion 2.

Similarly, said second stop 44 is configured to limit the rotation of the cam 4 when it is in the free sliding position P4. The second stop 44 requires that the counterclockwise rotation of the cam 4 is limited by the free sliding position P4. According to the depicted embodiment, said second stop 44 is a pin constrained to said second portion 2. The positioning of the second stop 44 on the second portion 2 allows, when said second portion 2 is in the open position P1, an additional rotation of the cam 4 in the free sliding position P4, as depicted in FIG. 4. This way, the insertion of the rope F within the first passage C1 is facilitated, without any resistance caused by the interposition of the same cam 4. In other embodiments not depicted, the second stop 44 is constrained to other components of the device 100, e.g. the first portion 1.

As depicted in more detail in FIGS. 8 and 9A-C, the first hole 6 has an extension smaller than the second hole 7. As depicted, in fact, the first hole 6 covers, on said first portion 1, an area smaller than the area covered by the second hole 7 on the second portion 2. In other words, according to a possible embodiment, the first hole 6 is, in projection, substantially contained within the second hole 7. The dimensioning of said holes ensures that the first connector K coupled to the device 100 through said first and second holes rests substantially only on the perimeter defining the first hole 6, as shown in the configurations of FIGS. 8 to 11.

In the depicted embodiment, said first portion 1 and second portion 2 comprise respective flaps 1C2, 2C2 configured to close, with said cam 4, said second passage C2 when said second portion is in the closed position P2. Said flaps 1C2, 2C2 can be observed in FIGS. 2 and 7 and are configured as lips departing from the main extension surfaces of said first and second portions. When said second portion 2 is in the closed position P2, said flaps 1C2, 2C2 are facing at such a distance as to prevent the passage of the rope F possibly housed within the second passage C2. In this embodiment, the second passage C2 is closed between the first portion 1, the second portion 2 and the rear portion of the cam 4 which is substantially coinciding with the axis of rotation R2.

As shown in FIGS. 3A-B, 4 and in FIGS. 10-11, during use, said first portion 1 and second portion 2 comprise, at their respective perimeter edges, at least one indentation 1K2, 2K2 configured for supporting a further connector K2 when said second portion 2 is in the closed position P2. As can be observed in FIGS. 10 and 11, the further connector K2 is not the same first connector K intended to be coupled to the device 100 through said first hole 6 and second hole 7. Said indentation 1K2, 2K2 is configured as a concavity shaped in the outer profile of the first portion 1 and the second portion 2. This indentation 1K1, 2K2 is adapted to allow the support of said further connector K2 which is substantially positioned around said first and second portions in order to contain them at least partially, as shown in FIGS. 10 and 11, wherein the further connector K2 is substantially contained between said indentation 1K2, 2K2 and the rope F.

Hereinafter, with reference to FIGS. 8 to 14, some configurations that can be assumed by the device 100 following the operation of the respective configuration method are described.

The configuration method for the device 100 comprises the following main steps:
opening said device 100 by bringing said second portion 2 to the open position P1;
housing at least one rope 2 in at least one closed passage comprised between said first portion 1 and said second portion 2;
closing said device 100 by bringing said second portion 2 into the closed position P2 in such a way that the rope F remains in the gap between said first portion 1 and said second portion 2.

The different configurations assumed by the device 100 are characterised by the way the step of housing the rope F within the same device 100 is performed.

In a first configuration depicted in FIG. 8, the step of housing the rope F provides for housing said rope F in said first passage C1. Once said rope F has been inserted, the configuration method also comprises a step of coupling said first connector K to the device 100 through said first hole 6 and second hole 7. Preferably, the first connector K is not crossed by said rope F, i.e. the rope F is not passing within the section of the first connector K. This first connector K is then connected to a load, e.g. to a person's harness. In this embodiment, the device 100 can be used, e.g., as a braking/locking device of a load connected to said first connector K, where it is necessary to ascend along a rope. Following the relative sliding between the device 100 and the rope F in one direction, specifically a downward sliding of the device 100 in the perspective of FIG. 8, the cam 4 moves to the interference position P3 and throttles the rope F in the first channel C1, thus preventing a subsequent movement of the device 100 and, therefore, of the load connected thereto. Following the relative sliding between the device 100 and the rope F in a direction opposite the previous one, the cam 4 is brought to the free sliding position P4 and the relative sliding between the device 100 and the rope F is not obstructed.

In a second configuration depicted in FIGS. 9A-C, the step of housing the rope F provides for housing said rope F in said first passage C1, in said fourth passage C4 and in said second passage C2. Specifically, said rope F is passing, in a clockwise direction, through the second passage C2, through the fourth passage C4 in contact with the pulley 5 and, finally, through the first passage C1. According to an aspect of the present invention, the rope passing through passages C1, C4 and C2 follows an overall path having substantially a “U” shape, wherein the branches of the “U” consist of the passages C1 and C2. According to this aspect of the invention, the first hole 6 and the second hole 7 are arranged within the path of the rope (which as mentioned has substantially a “U” shape), formed by the passages C1, C2 and C4.

Once said rope F has been inserted, the configuration method also comprises a step of coupling said first connector K to the device 100 through the first hole 6 and the second hole 7. In particular, the first connector K is crossed by said rope F, i.e. the rope F is passing within the section of the first connector K. In this embodiment, the device 100 can be used as a braking/locking device, e.g. in the recovery operations, of a load connected to an end of the rope F exiting from the first passage C1, as depicted in FIGS. 9A and 9B, or to said first connector K, as in the configuration of FIG. 9C. In this configuration, when the rope is subjected to the tension due to the weight force of the load, the cam 4 is in the interference position P3 and brakes/locks the descent of the load. By acting on the end of the rope exiting the second passage C2, it is possible to exert a tensile force sufficient to overcome the weight force of the load, bring the cam 4 into the free sliding position P4 and lift the load. By interrupting the traction, the cam 4 is returned to the interference position P3 and the sliding of the rope F in the device 100 is braked/locked. Preferably, the device 100 is connected to an anchoring point by the first connector K.

FIGS. 10 and 11 depict a variation of the first configuration just described. In this variation, in fact, the rope F follows the same path described in reference to FIGS. 8 and 9A-C but the configuration method provides, prior or subsequent to the step of housing said rope F, for a step of housing said further connector K2 in said indentation 1K2, 2K2. Said further connector K2 is interposed between the rope F and the perimeter edge of said first portion 1 and second portion 2 at said indentation 1K2, 2K2. As described above, in this variation, the further connector K2 is positioned substantially around said first and second portions to at least partially contain them and is restrained within said indentation 1K2, 2K2 by said first connector K and said first portion 1 and second portion 2. The housing of the further connector K2 has the purpose of providing additional friction, in situations where the secured load has to be rappelled, and, therefore, a more controlled and less abrupt handling of the descending movement of the same load.

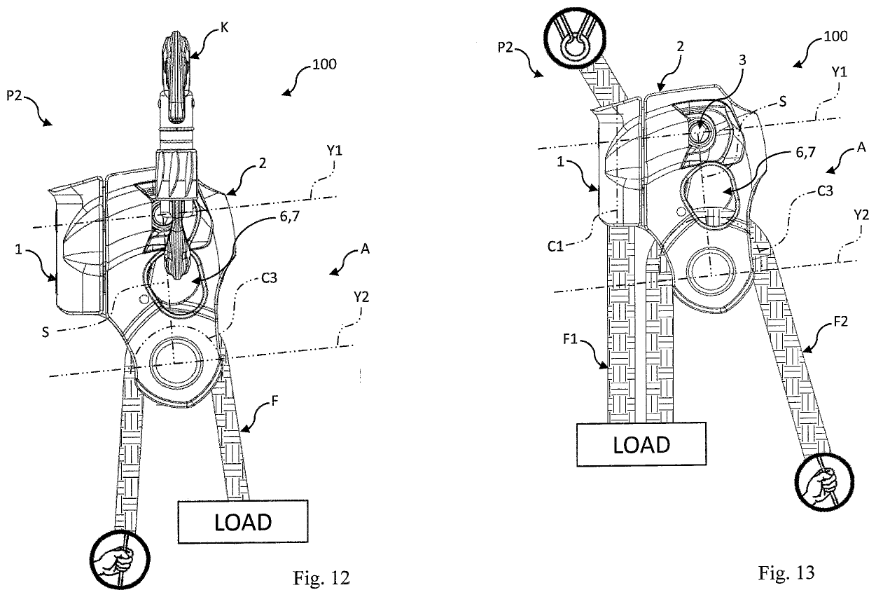

FIG. 12 depicts a third configuration of the device 100 wherein the step of housing the rope F provides for housing said rope F in said third passage C3. In other words, in said configuration, the rope F is housed in a gap closed between said first portion 1, said second portion 2, said cam 4 and said pulley 5. In particular, the rope F is in contact with said pulley 5 to facilitate relative sliding between the same rope and the device 100. In this configuration, either preliminarily or subsequently, the configuration method comprises a step of coupling the first connector K to said device 100 through said first hole 6 and second hole 7. In the embodiment depicted in FIG. 12, the device 100 is used to set up a sheave for moving a load connected to an end of the rope F and said first connector K is not crossed by said rope F.

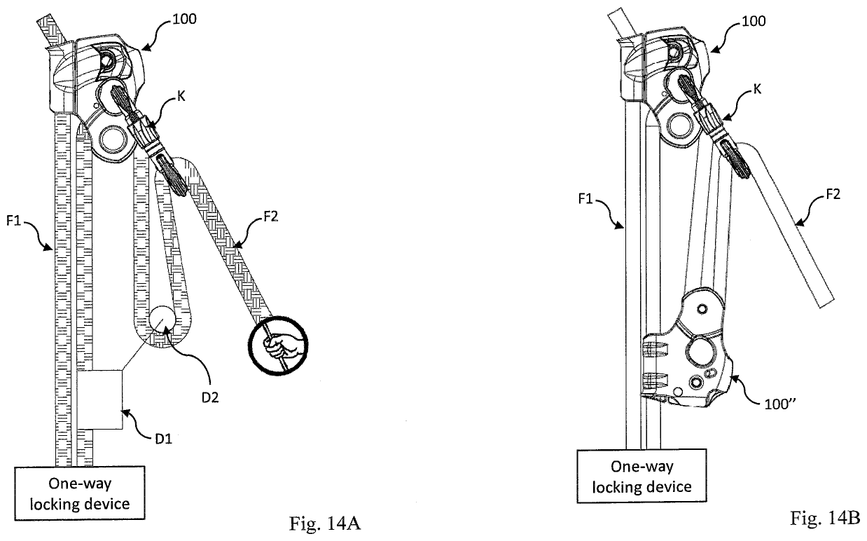

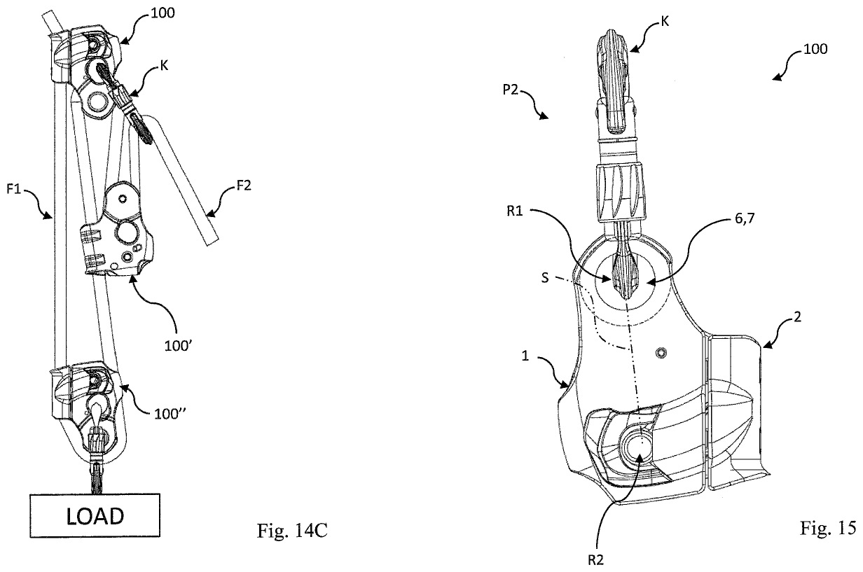

FIGS. 13 and 14 show a fourth configuration of device 100 wherein the step of housing said rope F provides for housing a first branch F1 of said rope F in said first passage C1 and a second branch F2 of said rope F in the third passage C3 closed between said cam 4 and said pulley 5. It should be noted that said first branch F1 and said second branch F2 may be distinct sections of the same rope and not two distinct ropes. In particular, between said first branch F1 and second branch F2, a load to be secured is positioned, e.g. by means of an additional connector, by means of a locking/braking device (one-way locking device in the accompanying FIGS. 14A-B) or by means of a further device 100 (FIG. 14C). In this embodiment, the device 100 can be used to set up a recovery hoist, e.g. a simple hoist as the one shown in FIG. 13 without the cooperation with other devices.

FIG. 14 depicts a hoist with multiplying gear, i.e. a variation of the simple hoist of FIG. 13, for moving, e.g. lifting, with a more favourable force ratio a load to be recovered. In this variation, the configuration method also comprises a step of coupling said first connector K to the device 100 through the first hole 6 and the second hole 7. The step of housing said rope F provides for housing the portion of the second branch F2, which is interposed between the device 100 and an end adapted to be operated, through said first connector K. Said configuration method provides for housing a first additional device D1, e.g. a braking/locking device (however, it is not excluded that a second device 100 may be used in the configuration of FIG. 8), along the portion of the second branch F2 between the load to be secured and the device 100. Furthermore, the configuration method provides for housing a second additional device D2 along the portion of second branch F2 interposed between the device 100 and the first connector K. Said second additional device D2 may be a pulley (however, it is not excluded that a second device 100 may be used in the configuration of FIG. 12) connected to the first additional device D1, e.g. by means of a connector or karabiner, or directly a connector/karabiner connected to the first additional device.

As further confirmation of the usefulness and versatility of device 100, the same manoeuvre mentioned above of hoist with multiplying gear can be advantageously carried out by using a second device 100 (such as e.g. shown in FIG. 14B) which incorporates the features of the devices D1 and D2 of FIG. 14, and even a third device 100 can be used as a “one way locking device” (such as e.g. shown in FIG. 14C).

The device 100 described above may, therefore, be used to set up a plurality of manoeuvres, depending on how the rope F is housed within the passages C1, C2, C3 and C4 and depending on any additional devices used. These manoeuvres are summarised, with exemplary reference to the attached figures, in the following list:
locking/braking (e.g. which can be seen in FIG. 8): rope F only passing through the first passage C1 and load connected to the first connector K;
locking for recovery (e.g. which can be seen in FIGS. 9A-C, 10 and 11): rope F passing through the first passage C1, fourth passage C4 and second passage C2 and load secured either to an end of the rope F (FIGS. 9A, 9B, 10 and 11) or, in the form of a simple hoist that theoretically halves the force necessary for lifting, net of friction, to the first connector K (FIG. 9C);
sheave (e.g. which can be seen in FIG. 12): rope F passing through the third passage C3 and load connected to an end of the rope F or to the first connector K;
simple hoist (e.g. which can be seen in FIG. 13): first branch F1 of the rope F passing through the first passage C1, second branch F2 of the rope F passing through the third passage C3 and load connected to said first branch F1 and second branch F2;
hoist with multiplying gear (e.g., which can be seen in FIG. 14): first branch F1 of the rope F passing through the first passage C1, second branch F2 of the rope F passing through the third passage C3, load connected to said first branch F1 and second branch F2, first additional device D1 on said second branch F2 between said load and said device 100 and second additional device D2, which is directly or indirectly connected to the first additional device D1, on said second branch F2 in the position opposite the first additional device D1 with respect to the device 100. Alternatively, the same hoist with multiplying gear can be obtained by replacing D1 and D2 with a second device 100, or even a third device 100 as a “one-way locking device”.

1. A multifunction device (100) adapted to house at least one rope (F), comprising:
a first fixed portion (1) comprising a main extension plate (10) and an abutment wall (11) which define a first passage (C1) for said rope (F);
a first axis of rotation (R1) constrained to said first portion (1) and extending along a first direction (X1);
a second portion (2) movable with respect to said first portion (1), said second portion (2) being connected to said first axis of rotation (R1) to rotate around said first direction (X1) between an open position (P1), wherein said rope (F) can be housed in or extracted from said multifunction device (100), and a closed position (P2), wherein said rope (F) is contained in said multifunction device (100);
a second axis of rotation (R2) constrained to said first portion (1) and extending along a second direction (X2);
a movable cam (4) mounted on said second axis of rotation (R2) and configured to rotate around said second direction (X2) between an interference position (P3) with said first passage (C1), wherein said cam (4) occupies at least partially said first passage (C1), and a free sliding position (P4), wherein said cam (4) does not interfere with said first passage (C1);
a pulley (5) mounted on said first axis of rotation (R1) to rotate around said first direction (X1); and
at least one first seat (6) on said first portion (1) and at least one second seat (7) on said second portion (2), said at least one first seat (6) and at least one second seat (7) being, at least when said second portion (2) is in the closed position (P2), at least partially coinciding to couple a first connector (K) to the multifunction device (100) and being arranged in an area (A) comprised between two straight lines (Y1, Y2) passing through the ends of a segment(S) connecting said first axis of rotation (R1) and said axis of rotation (R2) and perpendicular to said segment(S).

2. The multifunction device (100) according to claim 1, wherein said first portion (1) and said second portion (2), at least when said second portion (2) is in the closed position (P2), define at least one of:
a second passage (C2) for said rope (F), said second passage (C2) being opposite the first passage (C1) with respect to said second axis of rotation (R2);
a third passage (C3) closed for said rope (F) between said cam (4) and said pulley (5); and
a fourth passage (C4) for said rope (F), said fourth passage (C4) being opposite said third passage (C3) with respect to said first axis of rotation (R1).

3. The multifunction device (100) according to claim 2, wherein said second axis of rotation (R2) can be reversibly engaged to said second portion (2) and comprises a restraining system (3) configured to keep said second portion (2) in said closed position (P2), said restraining system (3) being operable to bring said second portion (2) into said open position (P1).

4. The multifunction device (100) according to claim 3, wherein said restraining system (3) comprises a spring-loaded button adapted to be operated to allow the second portion (2) to switch from the closed position (P2) to the open position (P1).

5. The multifunction device (100) according to claim 1, wherein said cam (4) comprises an increased friction surface (41), adapted to contact said rope (F) when said cam (4) is in the interference position (P3).

6. The multifunction device (100) according to claim 1, wherein said cam (4) comprises a return element (42) configured to return said cam (4) to the interference position (P3).

7. The multifunction device (100) according to claim 1, wherein said cam (4) comprises a manual control device configured to move said cam (4) between said interference position (P3) and said free position (P4).

8. The multifunction device (100) according to claim 1, further comprising a first end stop (43) configured to limit the rotation of the cam (4) when it is in the interference position (P3) and constrained to said first portion (1), and/or a second end stop (44) configured to limit the rotation of the cam (4) when it is in the free sliding position (P4) and constrained to said second portion (2).

9. The multifunction device (100) according to claim 1, wherein said at least one first seat (6) comprises at least one first hole and/or said at least one second seat (7) comprises at least one second hole.

10. The multifunction device (100) according to claim 9, wherein said at least one first seat (6) comprises at least one first hole and said at least one second seat (7) comprises at least one second hole and said at least one first hole has an extension smaller than the at least one second hole.

11. The multifunction device (100) according to claim 1, wherein said at least one first seat (6) and at least one second seat (7) are arranged in a sub-area (A′) of said area (A) comprised between said straight lines (Y1,Y2) and two additional straight lines (Y3,Y4) perpendicular to the aforesaid straight lines (Y1,Y2) and tangent to said pulley (5).

12. The multifunction device (100) according to claim 1, wherein said at least one first seat (6) and at least one second seat (7) are arranged along said segment(S) which links said first axis of rotation (R1) and said axis of rotation (R2).

13. The multifunction device (100) according to claim 12, wherein said at least one first seat (6) and at least one second seat (7) are positioned in a central portion of said segment(S) which links said first axis of rotation (R1) and said second axis of rotation (R2).

14. The multifunction device (100) according to claim 12, wherein said at least one first seat (6) and at least one second seat (7) are positioned at said first axis of rotation (R1), said first axis of rotation (R1) being hollow, or at said second axis of rotation (R2), said second axis of rotation (R2) being hollow.

15. The multifunction device (100) according to claim 1, wherein said first portion (1) and second portion (2) comprise respective flaps (1C2, 2C2) configured to close, with said cam (4), said second passage (C2) when said second portion (2) is in the closed position (P2).

16. The multifunction device (100) according to claim 1, wherein said first portion (1) and second portion (2) comprise, at a perimeter edge, at least one indentation (1K2,2K2) configured to house a further connector (K2) when said second portion (2) is in the closed position (P2).

17. A method of configuring the multifunction device (100) according to claim 1, comprising the steps of:
opening said multifunction device (100) by bringing said second portion (2) to the open position (P1);
housing at least one safety rope in at least one passage comprised between said first portion (1) and said second portion (2); and
closing said multifunction device (100) by bringing said second portion (2) to the closed position (P2), at least one passage being comprised between said first portion (1) and said second portion (2).

18. The method according to claim 17, wherein said step of housing said safety rope comprises housing said safety rope in said first passage (C1); said method further comprising a step of coupling a first connector (K) to said multifunction device (100) through said at least one first seat (6) and at least one second seat (7).

19. The method according to claim 17, wherein said step of housing said safety rope comprises housing said safety rope in said first passage (C1), in a fourth passage (C4) partially coinciding with said pulley (5) and in a second passage (C2) opposite said first passage (C1) with respect to said second axis of rotation (R2); said method further comprising a step of coupling a first connector (K) to said multifunction device (100) through said at least one first seat (6) and at least one second seat (7), said first connector (K) being crossed by said safety rope.

20. The method according to claim 19, wherein said first portion (1) and second portion (2) comprise, at a perimeter edge, at least one indentation (1K2,2K2) configured to house a further connector (K2) when said second portion (2) is in the closed position (P2), and said method further comprising, either before or after the step of housing said rope (F), a step of housing said further connector (K2) in said indentation (1K2, 2K2), said further connector (K2) being interposed between said perimeter edge and said rope (F) at said indentation (1K2,2K2).

21. The method according to claim 17, wherein said step of housing said safety rope in said multifunction device (100) provides for housing said safety rope in a third passage (C3) closed between said cam (4) and said pulley (5), said method further comprising a step of coupling a first connector (K) to said multifunction device (100) through said at least one first seat (6) and at least one second seat (7).

22. The method according to claim 17, wherein said step of housing said safety rope in said multifunction device (100) provides for housing a first branch (F1) of said safety rope in said first passage (C1) and a second branch (F2) of said safety rope in a third passage (C3) closed between said cam (4) and said pulley (5), a load to be secured being positioned between said first branch (F1) and said second branch (F2).

23. System comprising:
a device (100) according to claim 1; and
at least one safety rope.

24. The system according to claim 23, further comprising at least one said first connector (K).
